(19) United States
(12) Patent Application Publication
(10) Pub. No.: US 2010/0263896 A1
(43) Pub. Date: Oct. 21, 2010

(54) HAND-HELD POWER TOOL HAVING A TWO-PART HOUSING

(76) Inventors: Jens Brennenstuhl, Albershausen (DE); Heiko Roehm, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/747,740

(22) PCT Filed: Nov. 21, 2008
(86) PCT No.: PCT/EP08/66009

§ 371 Date: Jun. 11, 2010

(30) Foreign Application Priority Data
Dec. 13, 2007 (DE) 10 2007 060 057.9

(51) Int. Cl. B25F 5/02

(52) U.S. Cl. 173/217

(57) ABSTRACT

The invention relates to a hand-held power tool having a two-part housing, both housing parts being held together, by means of a connecting part, in such a manner that the housing parts can move in relation to each other.

The invention relates to a hand-held power tool, in particular an electrically operated hand-held power tool with the defining characteristics of the preamble to claim 1.

### PRIOR ART

DE 10 2004 051 913 A1 has disclosed a cordless screwdriver having a housing, which contains an electric drive motor that is supplied with current by a rechargeable battery. The rechargeable battery is permanently inserted into the housing.

There are also known cordless hand-held power tools whose rechargeable battery is embodied in the form of a replaceable battery pack that is flange-mounted to the housing of the power tool or can be detachably inserted into a recess provided for it. A power tool of this kind is described, for example, in DE 198 44 426 A1.

Both in hand-held tools with permanently integrated rechargeable batteries and ones with removable rechargeable batteries, the problem arises that there is a relatively large concentration of mass, on the one hand at the upper end of the hand-held power tool where the electric motor, the transmission, and the tool holder are situated and on the other hand, at the opposite end of the housing where the rechargeable battery is situated. If the tool is inadvertently dropped to the ground, there is the danger of damage, particularly to the middle region of the housing. In order to reduce the danger of breakage, the housing must be embodied as correspondingly stable and elastic.

In addition, in power tools powered by rechargeable batteries, it is necessary to take into account the fact that different voltage variants of these tools are sold. In order to implement this, different battery packs that have different interfaces must be fitted into the power tool, requiring a corresponding adaptation of the interfaces. In addition, different voltages must be used for different motor sizes so that both the motor and the battery have different dimensional requirements that affect the geometry of the housing.

### DISCLOSURE OF THE INVENTION

The object of the invention is to embody a rugged hand-held power tool by means of simple measures. It should be advantageously possible to easily adapt it to different motor variants and voltage variants.

This object is attained according to the invention with the defining characteristics of claim 1. Suitable modifications are disclosed in the dependent claims.

The hand-held power tool according to the invention, which is in particular an electrically operated hand-held power tool, preferably a cordless hand-held power tool, has a two-part housing with two housing parts embodied separately from each other, which are secured to each other by a connecting piece in a way that permits them to move in relation to each other. This embodiment achieves various advantages. On the one hand, the relative movement between the two housing parts permits a force reduction in the event that unforeseen high external forces act on the tool, for example in the event of an impact against the floor. The inherent damping of the material of the housing parts already achieves a force reduction; the possibility of relative movement permits the two housing parts to change their position relative to each other starting from a desired position and the deflection from the desired position results in a dissipation of energy. According to an advantageous embodiment, this effect is enhanced further by the fact that a cushion element is provided between the housing parts, which results in a damping of the relative movement.

On the other hand, the two-part housing embodiment has the advantage that depending on current requirements, different housing parts can be combined with one another, the only important requirement being for the housing parts to be uniformly embodied in the region of their connection. Because of the two-part structure of the housing, the number of different housing variants only increases in linear fashion, whereas with one-part housing embodiments, the number of housing variants increases progressively for the different battery packs and the different motor variants.

The connecting piece can be embodied in various ways. According to a preferred embodiment variant, the connecting piece is embodied as a connecting hinge with one rotational degree of freedom; the rotation axis of the hinge preferably extends perpendicular to the rotation axis of the tool and of the drive motor, which is electric as a rule. Basically, however, it is also possible for the rotation axis of the connecting hinge to be oriented differently from this. It is also conceivable to provide a connecting piece that has at least one translatory degree of freedom so that the two housing parts of the hand-held power tool to be connected to each other can slide in relation to each other. It is also possible for the connection to permit a plurality of translatory degrees of freedom, a plurality of rotatory degrees of freedom, or mixed translatory/rotatory degrees of freedom. A particularly simple embodiment, however, permits only one relative degree of freedom, for example a connecting hinge with only one possible rotation direction.

There are also various possible embodiments for the cushion element situated between the housing parts. For example, the damping property can be achieved through the selection of a damping material for the cushion element; possible candidates, for example, include rubber, rubber-like materials, or plastics such as thermoplastic elastomers (TPE) or SEBS. With an appropriate geometric embodiment, it is also conceivable to use metal cushion elements that are produced, for example, from a metal knit or contain a metal knit.

The cushion element preferably has damping properties. In addition, however, the cushion element can also act in a spring-like fashion; in this case, the cushion element also performs the function of a spring element or is embodied as one. This has the advantage that by means of the cushion element not only maintains the desired position between the housing parts during regular operation but is also causes it to be resumed after execution of a relative rotation between the housing parts. The spring element produces a return to the initial, desired position.

According to another advantageous embodiment, the cushion element is situated on only one side of the connecting piece and in addition, only damps the relative movement between the housing parts on this one side. The deflection in the opposite direction can be prevented by means of stops situated on the housing parts or directly on the connecting piece so that essentially, the only deflection permitted is in the direction toward the cushion element, which directly damps the deflection.

Other advantages and suitable embodiments can be inferred from the remaining claims, the description of the figures, and the drawings.

### DRAWINGS

FIG. 1 is a view of a hand-held power tool according to the invention, which is embodied in the form of a cordless drill or screwdriver and has a two-part housing; the two housing parts are rotatably secured to each other by means of a connecting hinge,

FIG. 2 shows a section through the connecting hinge.

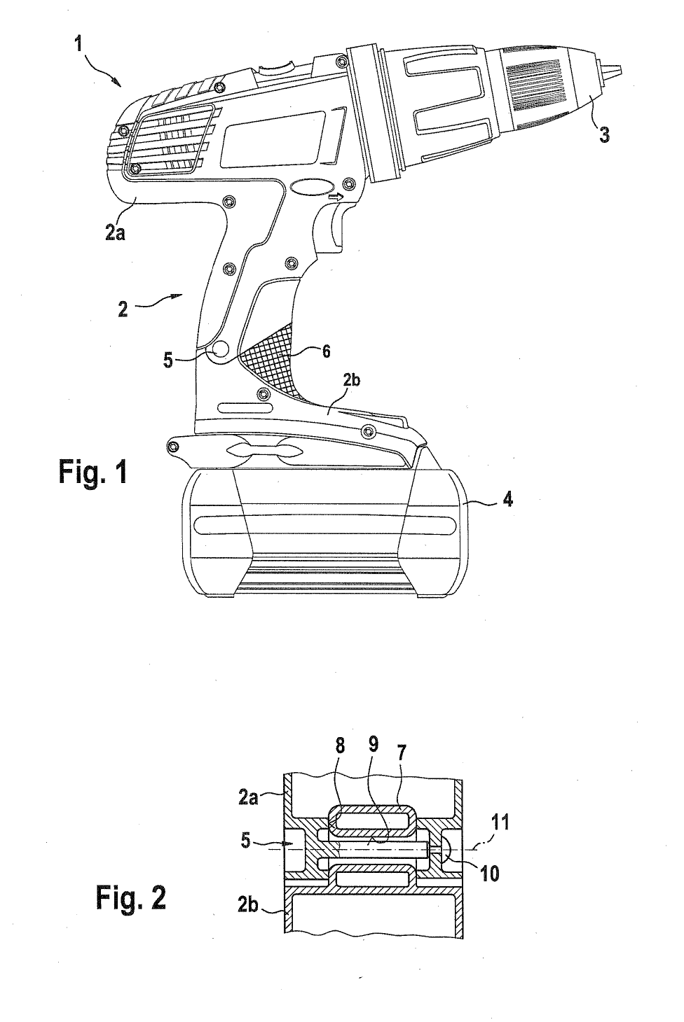

The hand-held power tool 1 shown in FIG. 1, which is embodied in the form of a cordless drill or cordless screwdriver, has a two-part housing 2 that has two separately embodied contiguous housing parts 2a and 2b. The first housing part 2a constitutes a motor housing for accommodating the electric motor, which drives a tool holder 3 that is embodied to accommodate the tool. The second housing part 2b constitutes a rechargeable battery receptacle, which is embodied to accommodate a battery pack 4 that supplies the electrical power to drive the electric motor.

The two housing parts 2a and 2b are rotatably coupled to each other by means of a connecting hinge 5. The rotation axis of the connecting hinge 5 is perpendicular to the motor axis and the rotation axis of the tool holder 3 and is also perpendicular to the handle axis. The connecting hinge 5 permits precisely one possibility for rotation between the two housing parts 2a and 2b. In the region of the connection by means of the connecting hinge 5, the two housing parts 2a and 2b form a handle for holding and guiding the hand-held power tool.

At the level of the connecting hinge 5, between the two housing parts 2a and 2b, a cushion element 6 likewise embodied as a separate component is provided, which damps the ability of the two housing parts 2a and 2b to rotate in relation to each other around the rotation axis of the hinge 5. In addition, the cushion element 6 stabilizes the two housing parts 2a and 2b in a desired position. The deflection around the rotation axis of the connecting hinge 5 occurs only upon exertion of powerful external forces that are correspondingly damped by the cushion element 6. In addition, the cushion element 6 has spring-like properties so that when the housing parts 2 are deflected out of their desired position, they are then returned to their original position.

The cushion element 6 is suitably produced out of a damping, springy material such as rubber, a rubber-like material, or a plastic material. With an appropriate structural embodiment, it is also conceivable for it to be embodied in the form of a metal component. It is optionally possible for a separate spring element to be integrated into the cushion element 6.

The cushion element 6 is inserted into a recess situated at the transition between the two housing parts 2a and 2b. The cushion element 6 is situated on only one side of the connecting hinge 5; on the side opposite from the cushion element 6, corresponding shoulders of the two housing parts 2a and 2b rest directly against each other in the desired or starting position so that it is not possible for them to rotate in this direction. The rotation can only occur in the direction toward the cushion element 6.

In the region of the connecting hinge 5 and the cushion element 6, the two housing parts 2a and 2b form a handle that is embodied as narrower than the other sections of the housing parts in order to permit an ergonomic grip. Despite the pronounced distribution of weight, on the one hand in the housing part 2a containing the motor and on the other hand in the housing part 2b where the battery pack 4 is situated, and the relatively narrow grip region in the transition between the two housing parts 2a and 2b, the risk of housing breakage is considerably reduced because of the possibility for relative movement by means of the connecting hinge 5 and the damping by means of the cushion element 6.

As is clear from the sectional depiction according to FIG. 2, the connecting hinge 5 is not embodied as a separate component, but is instead embodied as integrally joined to the two housing parts 2a and 2b through a suitable embodiment. The housing part 2b has a projection 7 for insertion into a recess 8 in the housing part 2a. The projection 7 contains another recess 9 that is flush with the recess 8 when the housing part 2b is in the inserted state so that a screw 10 can be inserted through the recess 9, on the one hand constituting the rotation axis 11 and on the other hand, attaching the two housing parts 2a and 2b securely to each other.

In another embodiment, one of the housing parts is embodied in the form of a multi-component part, with the cushion element as part of the housing.

1-12. (canceled)

13. A hand-held power tool, in particular an electrically operated hand-held power tool, having a drive unit situated in a housing, the housing having two separate housing parts that are secured to each other by means of a connecting piece in a way that permits the two housing parts to move in relation to each other.

14. The hand-held power tool as recited in claim 13, wherein the connecting piece permits exactly one relative degree of freedom between the two housing parts.

15. The hand-held power tool as recited in claim 13, wherein the connecting piece is embodied in the form of a connecting hinge with one rotational degree of freedom.

16. The hand-held power tool as recited in claim 14, wherein the connecting piece is embodied in the form of a connecting hinge with one rotational degree of freedom.

17. The hand-held power tool as recited in claim 13, wherein a cushion element is situated between the two housing parts.

18. The hand-held power tool as recited in claim 14, wherein a cushion element is situated between the two housing parts.

19. The hand-held power tool as recited in claim 15, wherein a cushion element is situated between the two housing parts.

20. The hand-held power tool as recited in claim 17, wherein the cushion element is produced from a damping material.

21. The hand-held power tool as recited in claim 18, wherein the cushion element is produced from a damping material.

22. The hand-held power tool as recited in claim 19, wherein the cushion element is produced from a damping material.

23. The hand-held power tool as recited in claim 20, wherein the cushion element is composed of rubber or a rubber-like material.

24. The hand-held power tool as recited in claim 21, wherein the cushion element is composed of rubber or a rubber-like material.

25. The hand-held power tool as recited in claim 22, wherein the cushion element is composed of rubber or a rubber-like material.

26. The hand-held power tool as recited in claim 17, wherein the cushion element is composed of metal and in particular, is produced from a metal knit.

27. The hand-held power tool as recited in claim 17, wherein the cushion element has a spring element.

28. The hand-held power tool as recited in claim 15, wherein the cushion element damps the rotation movement of the connecting hinge in one rotation direction.

29. The hand-held power tool as recited in claim 17, wherein the cushion element damps the rotation movement of the connecting hinge in one rotation direction.

30. The hand-held power tool as recited in claim 13, wherein the connecting piece and the cushion element combine to form a single component.

31. The hand-held power tool as recited in claim 13, embodied in the form of a cordless hand-held power tool, with one housing part constituting a motor housing for accommodating the electric motor and a second housing part constituting a battery-accommodating housing for accommodating a battery pack.

32. The hand-held power tool as recited in claim 31, wherein the connecting piece is situated in a half of a handle adjacent to the battery pack.
